(19) United States
(12) Patent Application Publication
(10) Pub. No.: US 2021/0374249 A1
(43) Pub. Date: Dec. 2, 2021

(54) POWER SIDE-CHANNEL ATTACK VULNERABILITY ASSESSMENT SYSTEMS AND METHODS

(71) Applicant: Intel Corporation, Santa Clara, CA (US)

(72) Inventors: Bilgiday Yuce, Santa Clara, CA (US); Sayak Ray, Santa Clara, CA (US); Majid Sabbagh, Santa Clara, CA (US); Xueyang Wang, Portland, OR (US); Monodeep Kar, Atlanta, GA (US); Hareesh Khattri, Hillsboro, OR (US); Jason Fung, Portland, OR (US)

(21) Appl. No.: 16/887,602

(22) Filed: May 29, 2020

(51) Int. Cl. G06F 21/57; G06F 21/75

(52) U.S. Cl. CPC G06F 21/577; G06F 2221/034; G06F 21/755

(57) ABSTRACT

The present disclosure detects and/or prevents power analysis side-channel attacks without requiring the use of external measurement devices. A first portion of field programmable gate array (FPGA) circuitry is configured to provide emulated hardware device circuitry and a second portion of the FPGA circuitry is configured to provide power monitoring circuitry. The emulated hardware device circuitry and the power monitoring circuitry are coupled to FPGA power distribution network circuitry. The power monitoring circuitry includes time-to-digital converter (TDC) circuitry that includes observation delay buffers to sample a clock propagation delay. Since the voltage supplied to the buffer circuitry affects the propagation delay, the TDC circuitry outputs a binary sequence representative of one or more power delivery parameters to the emulated hardware device circuitry. Analysis circuitry uses the collected data representative of one or more power delivery parameters to determine the susceptibility of the emulated hardware device circuitry to a power analysis side-channel attack.

### TECHNICAL FIELD

The present disclosure relates to computer security, specifically detection and/or prevention of side-channel attacks based on power consumption.

### BACKGROUND

Side-channel attacks represent a growing threat to security and privacy of modern computing systems. Among numerous side channels discovered so far, power side channel is arguably the oldest. Paul Kocher, et al. first reported in 1999 how secrecy of a cryptographic cipher implementation can be undermined using power analysis. Since then, the power side channel attack has continued to be a serious threat to hardware implementations, only proliferating in scope and ease. This is why designers of today's security-sensitive hardware devices are required to deploy specific mitigations in their designs against power side channel attacks. This is also the reason why accurate analysis of susceptibility of a hardware device to power side channel attack has become a crucial component of hardware security evaluation. Current state-of-the-art of power side channel analysis, however, relies heavily on sophisticated equipment, specialized experimental set up and deep knowledge of physical attacks. This makes the art of power side channel analysis privy to a limited group of experts. With the rapid growth of power side channel attack, it is important to remove these barriers as much as possible and make the art accessible to a larger audience of hardware designers.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 provides a high level block diagram of an illustrative power analysis side-channel attack vulnerability assessment system that includes field programmable gate array (FPGA) circuitry configured to provide emulated hardware device circuitry, power monitoring circuitry, interface circuitry, and power distribution network circuitry, the FPGA circuitry communicatively couples to a host device via a communications link, in accordance with at least one embodiment described herein;

FIG. 2 is a schematic diagram of an illustrative power analysis side-channel attack vulnerability assessment system that includes an FPGA system coupled to a host device via one or more communications links, in accordance with at least one embodiment described herein;

FIG. 3A is a schematic diagram of illustrative power monitoring circuitry that includes time-to-digital conversion (TDC) circuitry, in accordance with at least one embodiment described herein;

FIG. 3B a schematic diagram of illustrative power monitoring circuitry 112 that includes a plurality of parallel time-to-digital conversion (TDC) circuits 300A-300n, in accordance with at least one embodiment described herein; and

FIG. 4 is a high level logic flow diagram of an illustrative power analysis side-channel attack vulnerability assessment method, in accordance with at least one embodiment described herein; and

FIG. 5 and the following discussion provide a brief, general description of the components forming an illustrative processor-based device capable of implementing FPGA such as depicted and described in detail in FIGS. 1-4 (above), in accordance with at least one embodiment described herein.

Although the following Detailed Description will proceed with reference being made to illustrative embodiments, many alternatives, modifications and variations thereof will be apparent to those skilled in the art.

### DETAILED DESCRIPTION

The systems and methods disclosed herein beneficially reduce this entry barrier to power analysis of hardware IPs before fabrication. The systems and methods disclosed herein solve the problem of reliable evaluation of susceptibility of a hardware device to power side channel attack without using any external electrical measurement device. The systems and methods disclosed herein implement this by estimating power consumption of the hardware device under test while emulating the hardware device using a field programmable gate array (FPGA) board. The measurement of power consumption necessary for the side-channel attack susceptibility analysis is obtained through a ‘probe-less’, indirect power monitor. The systems and methods disclosed herein beneficially provide side-channel attack susceptibility analysis capabilities having precision equal to the current state-of-the-art, but with more flexibility, portability and scalability, as well as with far less cost.

The systems and methods disclosed herein provide a hardware-software framework with the ‘probe-less’ power monitor as the central artifact, supported by various hardware and software modules. The ‘probe-less’ power monitor may include a hardware module that is co-emulated on the same FPGA chip alongside the hardware device under test. Today's FPGAs are designed in such a way that both the power monitor and the hardware device share the same power distribution network (PDN). This allows the power monitor to ‘snoop’ on the power consumption pattern of the emulated hardware device. The surrounding hardware and software components operate in unison to control, collect and analyze power trace data from the power monitor. Overall, the systems and methods disclosed herein advantageously detect power side channel attacks on an emulated hardware device before the device is committed to silicon. It can be used to detect power side channel in a new hardware device as well as test the effectiveness of a mitigation technique used to harden an existing hardware device against a known power side channel attack.

A power analysis side-channel attack vulnerability assessment system is provided. The system may include:
a configurable field-programmable gate array (FPGA) that includes:
   power distribution network circuitry;
   emulated hardware device circuitry operably coupled to the power delivery bus circuitry;
   memory circuitry; and
   power monitoring circuitry electrically coupled to the power delivery bus circuitry and physically coupled to the substrate, the monitoring circuitry to:
      monitor one or more power delivery parameters to the emulated hardware device circuitry contemporaneous with performance of a sequence of operations by the emulated hardware device circuitry;
      generate output data representative of the one or more power delivery parameters;
      store data representative of the one or more power delivery parameters in the memory circuitry;
   and a host device communicatively coupleable to the configurable field-programmable gate array, the host device including analysis circuitry to:
      receive at least a portion of the stored data representative of the one or more power delivery parameters to the emulated hardware device circuitry; and
      using the received data representative of the one or more power delivery parameters to the emulated hardware device circuitry, generate an output indicative of a vulnerability of the emulated hardware device circuitry to a power analysis side-channel attack.

A power analysis side-channel attack vulnerability assessment method is provided. The method may include:
monitoring, via power monitoring circuitry coupled to emulated hardware device circuitry, one or more power delivery parameters to the emulated hardware device circuitry contemporaneous with execution of code by the hardware device emulation circuitry;
generating, by the power monitoring circuitry, output data representative of the one or more power delivery parameters;
causing, by the power monitoring circuitry, a storage of data representative of the one or more power delivery parameters to the emulated hardware device circuitry in memory circuitry communicatively coupled to the power monitoring circuitry;
receiving by analysis circuitry communicatively coupled to the power monitoring circuitry, at least a portion of the stored data representative of the one or more power delivery parameters to the emulated hardware device circuitry; and
generating, by the analysis circuitry, an output indicative of a vulnerability of the hardware device emulation circuitry to a power side-channel attack using the received data representative of the one or more power delivery parameters to the emulated hardware device circuitry.

A power analysis side-channel attack vulnerability assessment system is provided. The system may include:
means for monitoring one or more power delivery parameters to emulated hardware device circuitry contemporaneous with execution of code by the emulated hardware device circuitry;
means for generating output data representative of the one or more power delivery parameters to the emulated hardware device circuitry;
means for storing the data representative of the one or more power delivery parameters to the emulated hardware device circuitry in memory circuitry communicatively coupled to the power monitoring circuitry; and
means for generating an output indicative of a vulnerability of the emulated hardware device circuitry to a power side-channel attack using the received data representative of the one or more power delivery parameters to the emulated hardware device circuitry.

A non-transitory storage device is provided. The non-transitory storage device includes instructions that, when executed by a host device communicatively coupled to field programmable gate array (FPGA) circuitry, cause the host device to:
configure a first portion of the FPGA circuitry to provide emulated hardware device circuitry and a second portion of the FPGA circuitry to provide power monitoring circuitry;
cause the power monitoring circuitry to monitor one or more power delivery parameters to the emulated hardware device circuitry contemporaneous with execution of code by the hardware device emulation circuitry;
cause the power monitoring circuitry to generate output data representative of the one or more power delivery parameters to the emulated hardware device circuitry;
cause the power monitoring circuitry to store the data representative of the one or more power delivery parameters to the emulated hardware device circuitry in memory circuitry communicatively coupled to the power monitoring circuitry;
transfer at least a portion of the stored data representative of the one or more power delivery parameters to the hardware device emulation circuitry from the memory circuitry to analysis circuitry; and
cause the analysis circuitry to generate an output indicative of a vulnerability of the emulated hardware device circuitry to a power side-channel attack using the received data representative of the one or more power delivery parameters to the emulated hardware device circuitry.

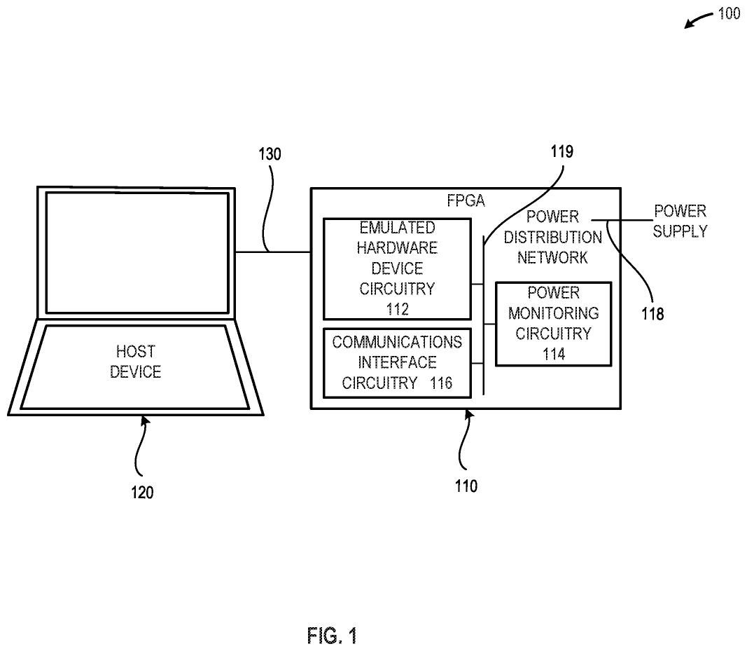

FIG. 1 provides a high level block diagram of an illustrative power analysis side-channel attack detection system 100 that includes field programmable gate array (FPGA) circuitry 110 configured to provide emulated hardware device circuitry 112, power monitoring circuitry 114, interface circuitry 116, and power distribution network circuitry 118; the FPGA circuitry 110 communicatively couples to a host device 120 via a communications link 130, in accordance with at least one embodiment described herein. One or more communication circuits 119 bidirectionally communicatively couple together the emulated hardware device circuitry 112, the power monitoring circuitry 114, and the communications interface circuitry 116. In embodiments, the one or more communications circuits 119 may include one or more serial communications buses, one or more parallel communications buses, or any combination thereof. The power distribution network circuitry 118 is operably coupled to at least the emulated hardware device circuitry 112 and the power monitoring circuitry 114. In operation, as the emulated hardware device circuitry 112 executes code, one or more power delivery parameters of the power provided to the emulated hardware device circuitry 112 by the power distribution network circuitry 118 fluctuate. The power monitoring circuitry 114 monitors, logs, and/or records the one or more power delivery parameters to the emulated hardware device circuitry 112. The power monitoring circuitry 114, periodically, aperiodically, continuously, or on an event-driven basis communicates the data representative of the one or more power delivery parameters to the host device 120. Beneficially, implementing the power monitoring circuitry 114 using the same FPGA circuitry 110 used to implement the emulated hardware device circuitry 112, eliminates the need for external power monitoring equipment such as oscilloscopes.

In embodiments, the host device 120 may be used to configure the FPGA circuitry 110 to emulate a prospective hardware device prior to committing the hardware device to silicon. The power monitoring circuitry 114 communicates the output data indicative of the one or more emulated hardware device circuitry 112 power delivery parameters to the host device 120 via the interface circuitry 116 and the communications link 130. The host device 120 analyzes the received data representative of the one or more power delivery parameters to the emulated hardware device circuitry 112 to detect fluctuations and/or patterns in the one or more power delivery parameters indicative of the susceptibility of the emulated hardware device circuitry 112 to a power analysis side-channel attack. Beneficially, the ability of the host device 120 to autonomously determine the susceptibility of the emulated hardware device circuitry 112 to power analysis side-channel attacks based on fluctuations, patterns, and/or trends in the one or more power delivery parameters permits designers to emulate their hardware designs, test the hardware design, and identify vulnerabilities without the need for costly and time consuming independent analysis.

The FPGA circuitry 110 includes any number and/or combination of currently available and/or future developed semiconductor devices based around a matrix that includes a plurality of configurable logic elements, such as a plurality of adaptive logic modules (ALMs) or configurable logic blocks (CLBs) connected via selectively programmable interconnects. Example FPGA circuitry 110 includes but is not limited to an Intel-based (Intel, Corporation, Santa Clara, Calif.) Arria 10 GX FPGA Development Kit, an Xilinx-based (Xilinx, Inc., San Jose, Calif.) SAKURA-G (Troche Co., Ltd., (YOKOHAMA, Japan) FPGA Kit or similar. In embodiments, the FPGA circuitry 110 may be configured to provide all or a portion of the emulated hardware device circuitry 112, all or a portion of the power monitoring circuitry 114, and all or a portion of the interface circuitry 116. The FPGA circuitry 110 also incorporates the power distribution network circuitry 118. The ability of the power monitoring circuitry 114 to detect the one or more power delivery parameters of the power distribution network circuitry 118 as the emulated hardware device circuitry 112 executes code permits the identification of vulnerabilities in the emulated hardware device circuitry 112 without requiring the use of external test equipment and/or the use of external analytical equipment.

The host device 120 configures at least a portion of the FPGA circuitry 110 to provide the emulated hardware device circuitry 112 which may also be referred to as “device under test” (DUT) circuitry. The host device 120 also configures at least a portion of the FPGA circuitry 110 to provide the power monitoring circuitry 114. The FPGA 110 includes the power distribution network circuitry 118 used to provide power to both the emulated hardware device circuitry 112 and the power monitoring circuitry 114. In embodiments, the host device 120 may autonomously configure the power monitoring circuitry 114. In other embodiments, one or more user inputs may be used to configure the power monitoring circuitry 114.

The power monitoring circuitry 114 may include any number and/or combination of currently available and/or future developed electronic components, semiconductor devices, and/or logic elements capable of monitoring, recording, logging, and/or storing the one or more power delivery parameters as the emulated hardware device circuitry 112 executes code. In embodiments, the power monitoring circuitry 114 may monitor one or more power delivery parameters such as: power distribution network voltage; power distribution network current; power distribution network PWM pulse duration; power distribution network PWM pulse magnitude; power distribution network PWM pulse frequency; or combinations thereof. In embodiments, the power monitoring circuitry 114 may have a sampling rate of about: 1 gigahertz (GHz) or more; 1 megahertz (MHz) or more; 1 kilohertz (KHz) or more.

In embodiments, the power monitoring circuitry 114 may store the collected one or more power delivery parameters in memory circuitry communicatively coupled to the power monitoring circuitry 114. In at least some embodiments, the power monitoring circuitry 114 may store the collected one or more power delivery parameters in memory circuitry included in the FPGA circuitry 110.

In embodiments, the power monitoring circuitry 114 may cause the transfer of data representative of the collected one or more power delivery parameters to the host device 120 on a periodic, aperiodic, intermittent, continuous, or event-driven basis. For example, the power monitoring circuitry 114 may “push” or cause the transfer of all or a portion of the collected data representative of the collected one or more power delivery parameters to the host device 120 on an event-driven basis at the upon the emulated hardware device circuitry 112 completing code execution. In other embodiments, the power monitoring circuitry 114 may “push” or cause the transfer of all or a portion of the collected data representative of the collected one or more power delivery parameters to the host device 120 upon detecting a fluctuation, pattern, or trend in all or a portion of the one or more power delivery parameters. In some embodiments, the sampling rate of the power monitoring circuitry 114 may be a fixed value (e.g., 100 MHz). In other embodiments, the sampling rate of the power monitoring circuitry 114 may be variable. For example, in some embodiments, the sampling rate of the power monitoring circuitry 114 may increase upon detecting or being otherwise notified of a fluctuation, pattern, or trend in all or a portion of the one or more power delivery parameters indicative of a potential power analysis side-channel attack.

The communications interface circuitry 116 communicatively couples the FPGA circuitry 110 to the host device 120. In embodiments, the communications link 130 may include one or more tethered or wired connections. For example, in some embodiments, the communications link 130 may include a universal serial bus (USB) connection. In other embodiments the communications link 130 may include one or more wireless connections. For example, in some embodiments, the communications link 130 may include one or more of: an IEEE 802.11 (WiFi) communications link, a cellular communications link, or combinations thereof. In embodiments, the host device 120 may be disposed local to the FPGA circuitry 110. In other embodiments, the host device 120 may be disposed remote from the FPGA circuitry 110. For example, in some embodiments, the FPGA circuitry 110 may be a cloud-based service and the host device 120 may be local to the prospective hardware device designer thereby enabling cloud based testing of the prospective hardware device.

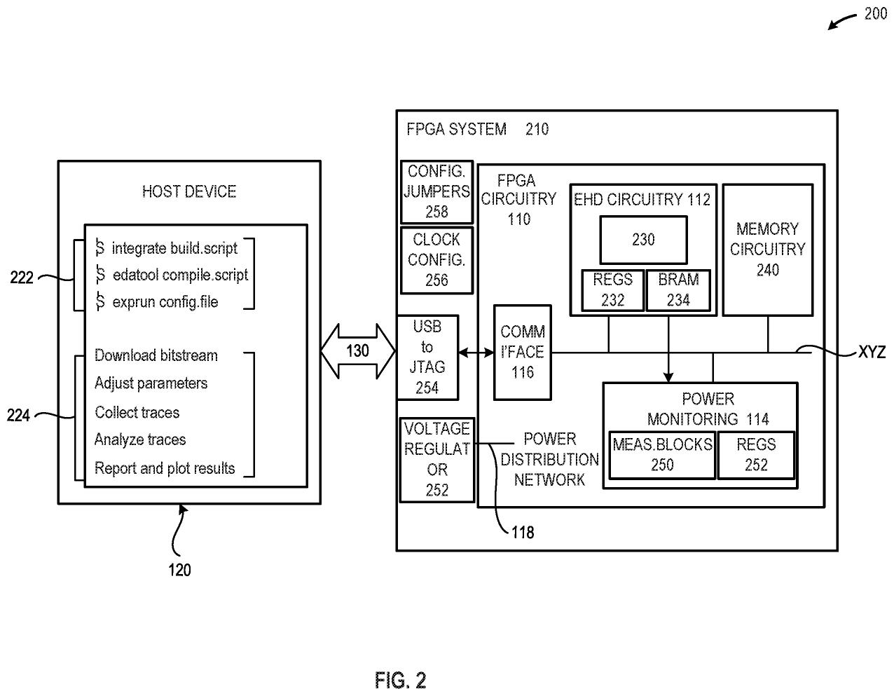

FIG. 2 is a schematic diagram of an illustrative power analysis side-channel attack detection system 200 that includes an FPGA system 210 coupled to a host device 120 via one or more communications links 130, in accordance with at least one embodiment described herein.

As depicted in FIG. 2, the host device 120 may include configuration circuitry 222 used to configure the emulated hardware device circuitry 112 in the FPGA circuitry 110. In at least some embodiments, the host device 120 may also configure the power monitoring circuitry 114 in the FPGA circuitry 110. The host device 120 includes power analysis circuitry 224 to receive and analyze the data representative of the one or more power delivery parameters received from the power monitoring circuitry 114 via the communications link 130.

As depicted in FIG. 2, the FPGA system 210 may include the FPGA circuitry 110, and additional devices and/or circuitry such as: FPGA system configuration jumpers 212; FPGA clock circuitry 214; USB to Joint Test Action Group (JTAG) interface circuitry 216; and power supply and/or conditioning circuitry 218. Also as depicted in FIG. 2, the FPGA circuitry 110 may include emulated hardware device circuitry 112 that includes an emulated hardware device 230 for testing; data storage register circuitry 232; and block random access memory (BRAM) circuitry 234. In addition, at least a portion of the FPGA circuitry 110 may include memory circuitry 240. In embodiments, the power monitoring circuitry 114 may include data storage register circuitry 250. As depicted in FIG. 2, the FPGA system 210 may include various other components such as clock circuitry 256 and configuration jumpers 258.

In embodiments, the power monitoring circuitry 114 may store data representative of the one or more power delivery parameters in at least one of: the data register circuitry 250 and/or the FPGA memory circuitry 240. In some embodiments, the analysis circuitry 224 may “pull” data representative of the one or more power delivery parameters from either or both the data storage registers 250 in the power monitoring circuitry 114 and/or the FPGA memory circuitry 240. In other embodiments, the power monitoring circuitry 114 may “push” data representative of the one or more power delivery parameters from at least one of the data register circuitry 250 and/or the FPGA memory circuitry 240 to the analysis circuitry 224.

As depicted in FIG. 2, in embodiments, the power monitoring circuitry 114 may include a plurality of measurement block circuits 252 and a plurality of control register circuits 254. In embodiments, the power monitoring circuitry 114 may receive trigger signals from the emulated hardware device circuitry 112. Such trigger signals may designate occurrence of one or more events simulating a power-analysis side-channel attack. Such trigger signals may cause the sampling rate of the power monitoring circuitry 114 to increase.

In embodiments, the host device 120 causes the emulated hardware device circuitry 112 to execute code. Contemporaneous with the execution of the code by the emulated hardware device circuitry 112, the power monitoring circuitry 114 monitors the one or more power delivery parameters on the power distribution network circuitry 118. Trace data, including at least the data representative of the one or more power delivery parameters may be stored in the FPGA memory circuitry 240 on a real-time or near-real time basis.

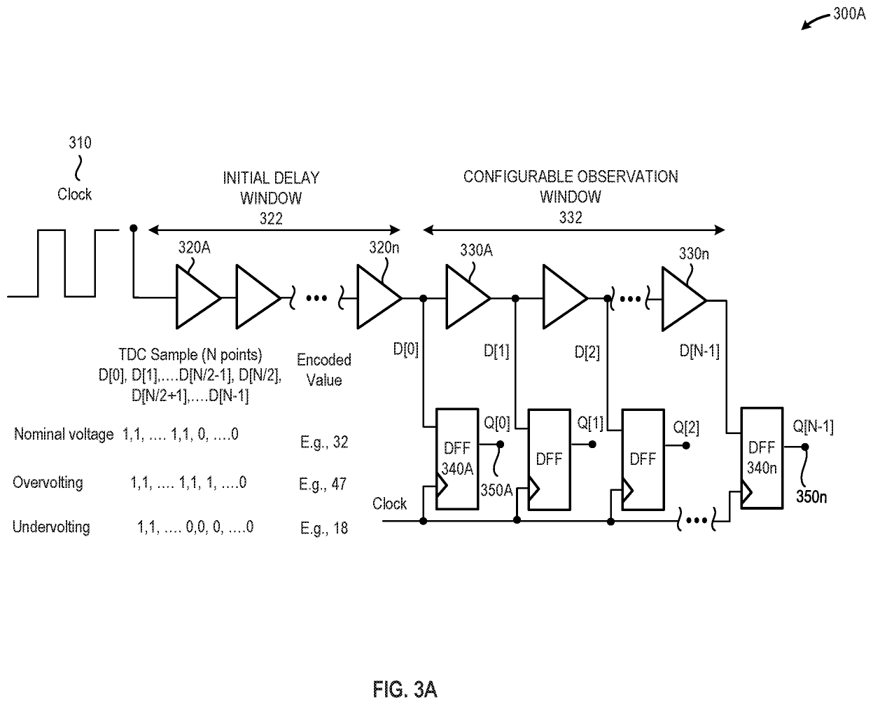

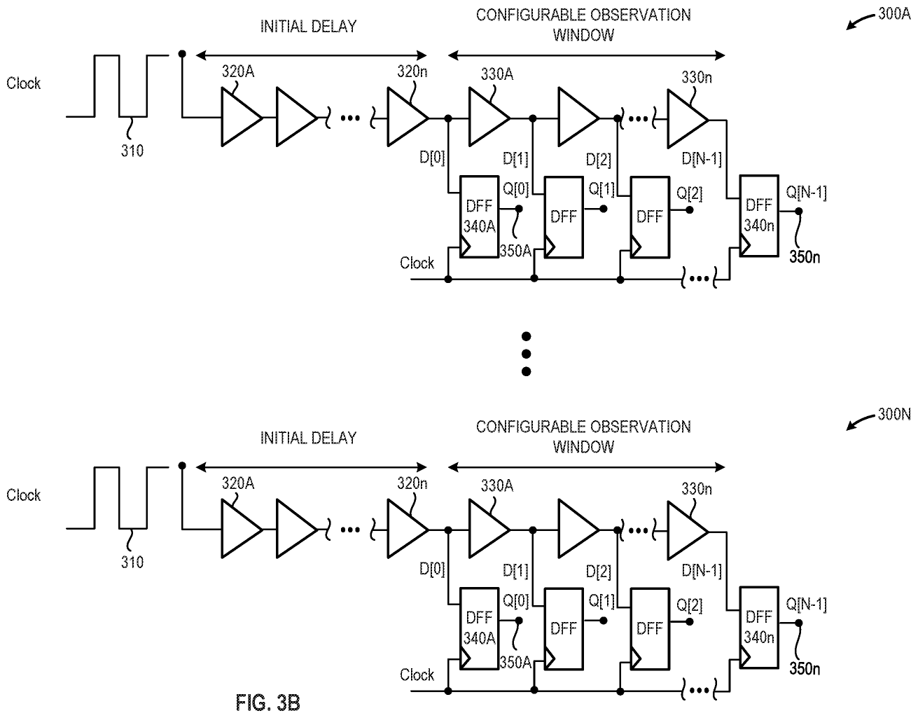

FIG. 3A is a schematic diagram of illustrative power monitoring circuitry 112 that includes time-to-digital conversion (TDC) circuitry 300, in accordance with at least one embodiment described herein. As depicted in FIG. 3A, the TDC circuitry 300 receives an input clock signal 310. The TDC circuitry 300 may include any number of delay buffer circuits that may be equally or unequally apportioned to provide a plurality of delay buffer circuits 320A-320n (collectively, “delay buffer circuits 320”) that provide an initial delay window 322 and a plurality of serially coupled observation delay buffer circuits 330A-330n (collectively, “observation delay buffer circuits 330”) that form a configurable observation window 332. The configurable observation window 332 includes a plurality of D-type flip-flop circuits (DFF) 340A-340n (collectively, “DFF circuits 340”). Each of the plurality of DFF circuits 340A-340n receives an input from a respective one of the observation delay buffer circuits 330A-330n. Each of the plurality of DFF circuits 340A-340n captures the output value of the respective observation delay buffer circuit 330A-330n using an input clock signal. The combined output signals 350A-350n from each of the DFF circuits 340A-340n provides the “observation window” for the one or more power delivery parameters. In embodiments, the observation delay buffer circuits 330 sample the clock propagation delay as the clock signal propagates through the observation delay buffer circuits 330. In embodiments, the TDC circuitry 300 may include any number of observation delay buffer circuits 330 and a corresponding number of DFF circuits 340. For example, the TDC circuitry 300 may include: 16 observation delay buffer circuits 330 and 16 DFF circuits 340; 32 observation delay buffer circuits 330 and 32 DFF circuits 340; 64 observation delay buffer circuits 330 and 64 DFF circuits 340; or 128 observation delay buffer circuits 330 and 128 DFF circuits 340. In embodiments, each of the buffer circuits (i.e., the delay buffer circuits 320A-320n and/or the observation buffer circuits 330A-330n) included in the TDC circuitry 300 may have a timing resolution of about: 10 picoseconds (ps) or less; 100 ps or less; 1 nanosecond (ns) or less; 10 ns or less; 100 ns or less; 1 microsecond (μs) or less; 10 μs or less; 100 μs or less; or 1 millisecond or less.)

The TDC circuitry 300 may include any number and/or combination of delay buffer circuits 320 and observation buffer circuits 330. In embodiments, the number of delay buffer circuits 320 included in the plurality of delay buffer circuits 320A-320n forming the initial delay window 322 may be variable and the number of observation buffers 330 included in the plurality of observation buffers 340A-340n forming the configurable observation window 332 may also be considered variable.

For example, in an illustrative embodiment, the TDC circuitry 300 may include a total of 96 delay buffer circuits. The host device 120 may apportion all or a portion of the 96 delay buffer circuits into a first portion to provide the initial delay window 322 that includes plurality of delay buffer circuits 320A-320n and a second portion to provide the configurable observation window that includes the plurality of observation buffer circuits 330A-330n. In a first example embodiment using the 96 delay buffer TDC circuitry 300, the host device 120 may allocate the first 32 delay buffer circuits (1-32) to provide the initial delay window 322 containing 32 delay buffer circuits 3201-32032 and the 64 remaining delay buffer circuits (33-96) to provide the configurable observation window 332 containing 64 delay buffer circuits 3301-33064. In a second example embodiment using the 96 delay buffer TDC circuitry 300, the host device 120 may allocate the first 16 delay buffer circuits (1-16) to provide the initial delay window 322 containing 32 delay buffer circuits 3201-32016 and 32 of the remaining 80 delay buffer circuits (17-48) to provide the configurable observation window 332 containing 32 delay buffer circuits 3301-33032. In such an embodiment, the remaining 48 delay buffers included in the TDC circuitry 300 may remain unused. Thus, the binary sequence representative of the one or more power delivery parameters may include any number of bits based on the number of delay buffer circuits apportioned by the host device 120 to provide the configurable observation window 332.

The average timing resolution for the TDC circuitry 300 may be characterized by the observation buffer delays. For example, the average timing resolution of the TDC circuitry may be: 10 picoseconds (ps) or less; 100 ps or less; 1 nanosecond (ns) or less; 10 ns or less; 100 ns or less; 1 microsecond (μs) or less; 10 μs or less; 100 μs or less; or 1 millisecond or less. The emulated hardware device circuitry 112 affects the voltage provided to the observation delay buffers 330 via the power distribution network circuitry 118. Based on the voltage supplied to the observation delay buffers 330, the propagation delay can either increase, thereby generating a smaller TDC sample encoded value (i.e., indicative of a relatively low power delivery parameter value, such as voltage, with respect to normal operating power delivery parameter value), or decrease, thereby generating a larger TDC sample encoded value (i.e., indicative of a relatively high power delivery parameter value, such as voltage, with respect to normal operating power delivery parameter value). In embodiments, The power monitoring circuitry 114 samples the propagation delay generating a binary sequence indicative of the one or more power delivery parameters to the emulated hardware device circuitry 112 using a TDC clock. In embodiments, the power monitoring circuitry 114 stores, holds, or otherwise retains the binary sequence indicative of the one or more power delivery parameters in the FPGA memory circuitry 240 while the emulated hardware device circuitry 112 executes code.

FIG. 3B a schematic diagram of illustrative power monitoring circuitry 112 that includes a plurality of parallel time-to-digital conversion (TDC) circuits 300A-300n, in accordance with at least one embodiment described herein. In embodiments, a plurality of TDC circuits 300A-300n, each similar to that described in FIG. 3A (above) may be combined in a parallel arrangement to obtain one or more power delivery parameters from each of a plurality of channels. Any number of TDC circuits 300A-300n may be arranged in parallel. For example, the power monitoring circuitry 114 may include: 2 or more TDC circuits 300 arranged in parallel; 4 or more TDC circuits 300 arranged in parallel; 8 or more TDC circuits 300 arranged in parallel; 16 or more TDC circuits 300 arranged in parallel; or 32 or more TDC circuits 300 arranged in parallel. Such an arrangement of TDC circuits 300A-300n beneficially improves the quality of our measurement and side-channel analysis by permitting combining of data representative of the one or more power delivery parameters generated by each of the plurality of TDC circuits 300A-300n. Beneficially, the improved measurement quality may also reduce the time required for data collection and analysis by the host device 120.

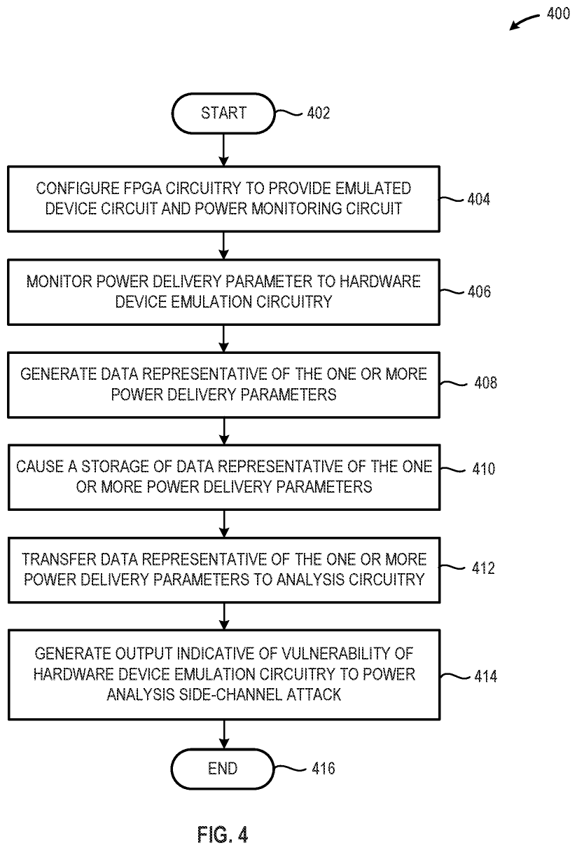

FIG. 4 is a high level logic flow diagram of an illustrative power analysis side-channel attack detection method 400, in accordance with at least one embodiment described herein. The method 400 beneficially permits testing the susceptibility of an FPGA emulated hardware device 112 to a power analysis side channel attack without requiring the use of external analysis devices such as an oscilloscope. In addition, by providing a method to test a prospective hardware device prior to committing the device to fabrication in silicon, the method 400 advantageously reduces the time and expense of testing prototypical hardware devices. The method commences at 402.

At 404, the host device 120 initializes and configures the FPGA circuitry to provide the emulated hardware device circuitry 112 and the power monitoring circuitry 114. For example, the host device 120 may configure the emulated hardware device circuitry 112 to provide the device under test and the power monitoring circuitry 114 to provide one or more TDC circuits 300 and the desired apportionment of delay buffer circuits in each of the one or more TDC circuits 300 to provide the initial delay window 322 and the configurable observation window 332 for each of the one or more TDC circuits 300. In embodiments, each of the one or more TDC circuits may include an initial delay window 322 having the same or differing numbers of delay buffer circuits. In embodiments, each of the one or more TDC circuits may include a configurable observation window 332 having the same or differing numbers of delay buffer circuits.

At 406, a first portion of FPGA circuitry 110 configured to provide power monitoring circuitry 114 monitors one or more power delivery parameters to a second portion of the FPGA circuitry 110 configured to provide emulated hardware device circuitry 112. In embodiments, the power monitoring circuitry 114 may monitor the one or more power delivery parameters using the FPGA power distribution network circuitry 118 that provides power to both the emulated hardware device circuitry 112 and to the power monitoring circuitry 114. In embodiments, the one or more power delivery parameters may include a voltage supplied to the emulated hardware device circuitry 112.

At 408, the power monitoring circuitry 114 generates data representative of the one or more power delivery parameters to the emulated hardware device circuitry 112. In embodiments, the power monitoring circuitry 114 includes time-to-digital conversion circuitry 300 that generates a binary sequence representative of the one or more power delivery parameters.

At 410, the power monitoring circuitry 114 stores the data representative of the one or more power delivery parameters to the emulated hardware device circuitry 112 in memory circuitry 240.

At 412, the stored data representative of the one or more power delivery parameters to the emulated hardware device circuitry 112 is transferred to analysis circuitry 224 in the host device 120. In embodiments, the host device 120 pulls the data representative of the one or more power delivery parameters to the emulated hardware device circuitry 112 from the memory circuitry 240. In other embodiments, the power monitoring circuitry 114 pushes the data representative of the one or more power delivery parameters to the emulated hardware device circuitry 112 to the host device 120.

At 414, analysis circuitry 224 in the host device 120 generates one or more outputs that include information indicative of the susceptibility of the emulated hardware device circuitry 112 to a power analysis side-channel attack. The method 400 concludes at 416.

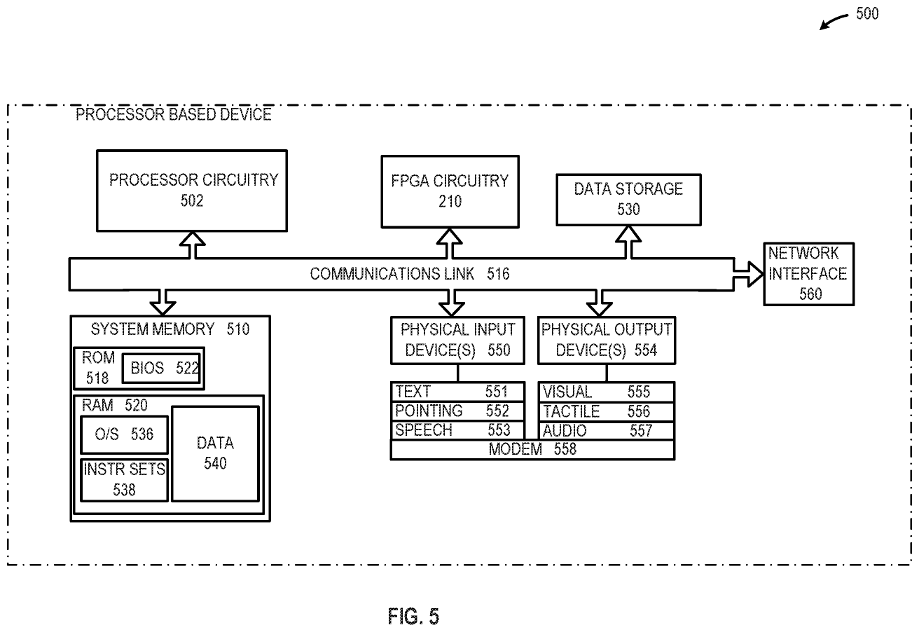

FIG. 5 and the following discussion provide a brief, general description of the components forming an illustrative processor-based device 500 that includes at least one of: internal FPGA 210 and/or an external FPGA 210 such as depicted and described in detail in FIGS. 1-4 (above), in accordance with at least one embodiment described herein. The processor-based device 500 includes processor circuitry 502. The processor circuitry 502 executes one or more applications. During execution, the applications may cause the processor circuitry 502 to perform one or more memory operations, such as a memory write operation or a memory read operation. Those skilled in the relevant art will appreciate that the illustrated embodiments as well as other embodiments can be practiced with other circuit-based device configurations, including portable electronic or handheld electronic devices, for instance smartphones, portable computers, wearable computers, microprocessor-based or programmable consumer electronics, personal computers (“PCs”), network PCs, minicomputers, mainframe computers, and the like. The embodiments can be practiced in distributed computing environments where tasks or modules are performed by remote processing devices, which are linked through a communications network. In a distributed computing environment, program modules may be located in both local and remote memory storage devices.

The processor circuitry 502 may include any number of circuits, some or all of which may include programmable and/or configurable combinations of electronic components, semiconductor devices, and/or logic elements that are disposed partially or wholly in a PC, server, or other computing system capable of executing machine-readable instructions. The processor-based device 500 may include processor circuitry 502, and may, at times, include a bus or similar communications link 516 that communicatively couples and facilitates the exchange of information and/or data between various system components including a system memory 510 and the processor circuitry 502. The processor-based device 500 may be referred to in the singular herein, but this is not intended to limit the embodiments to a single device and/or system, since in certain embodiments, there will be more than one processor-based device 500 that incorporates, includes, or contains any number of communicably coupled, collocated, or remote networked circuits or devices.

The processor circuitry 502 may include any number, type, or combination of devices. At times, the processor circuitry 502 may be implemented in whole or in part in the form of semiconductor devices such as diodes, transistors, inductors, capacitors, and resistors. Such an implementation may include, but is not limited to any current or future developed single- or multi-core processor or microprocessor, such as: on or more systems on a chip (SOCs); central processing units (CPUs); digital signal processors (DSPs); graphics processing units (GPUs); application-specific integrated circuits (ASICs), field programmable gate arrays (FPGAs), and the like. Unless described otherwise, the construction and operation of the various blocks shown in FIG. 5 are of conventional design. As a result, such blocks need not be described in further detail herein, as they will be understood by those skilled in the relevant art. The communications link 516 that interconnects at least some of the components of the processor-based device 500 may employ any known serial or parallel bus structures or architectures.

The system memory 510 may include read-only memory (“ROM”) circuitry 518 and random access memory (“RAM”) circuitry 520. A portion of the ROM circuitry 518 may be used to store or otherwise retain a basic input/output system (“BIOS”) 522. The BIOS 522 provides basic functionality to the processor-based device 500, for example by causing the processor circuitry 502 to load an operating system 536, one or more machine-readable instruction sets 538, and/or data 540 from the RAM circuitry 520. In embodiments, at least some of the one or more machine-readable instruction sets cause the controller circuitry 110 to selectively provide the memory integrity performance enhancement system as described herein.

The processor-based device 500 may include one or more communicably coupled, non-transitory, data storage devices 530. Although depicted in FIG. 5 as disposed internal to the processor-based device 500, in various embodiments, the one or more data storage devices 530 may be disposed local to and/or remote from the processor-based device 500. The one or more data storage devices 530 may include any current or future developed storage appliances, networks, and/or devices. Non-limiting examples of such data storage devices 530 may include, but are not limited to, any current or future developed non-transitory storage appliances or devices, such as one or more magnetic storage devices, one or more optical storage devices, one or more solid-state electromagnetic storage devices, one or more electro-resistive storage devices, one or more molecular storage devices, one or more quantum storage devices, or various combinations thereof. In some implementations, the one or more data storage devices 530 may include one or more removable storage devices, such as one or more flash drives, flash memories, flash storage units, or similar appliances or devices capable of communicable coupling to and decoupling from the processor-based device 500.

The one or more storage devices 530 may include interfaces or controllers (not shown in FIG. 5) communicatively coupling the respective storage device 530 or system to the communications link 316. The one or more storage devices 530 may contain machine-readable instruction sets, data structures, program modules, data stores, databases, logical structures, and/or other data useful to the processor circuitry 502 and/or the controller circuitry 110. In some instances, one or more external storage devices 530 may be communicably coupled to the processor circuitry 502, for example via communications link 310 or via one or more wired communications interfaces (e.g., Universal Serial Bus or USB); one or more wireless communications interfaces (e.g., Bluetooth®, Near Field Communication or NFC); one or more wired network interfaces (e.g., IEEE 802.3 or Ethernet); and/or one or more wireless network interfaces (e.g., IEEE 802.11 or WiFi®).

Machine-readable instruction sets 538 and data 540 may be stored in whole or in part in the system memory 510. Such instruction sets 538 may be transferred, in whole or in part, from one or more internal data storage devices and/or one or more external storage devices 530. The instruction sets 538 may be loaded, stored, or otherwise retained in system memory 510, in whole or in part, during execution by the processor circuitry 502.

Processor-based device users may provide, enter, or otherwise supply commands (e.g., acknowledgements, selections, confirmations, and similar) as well as information and/or data (e.g., subject identification information, color parameters) to the processor-based device 500 using one or more communicatively coupled physical input devices 550 such as one or more text entry devices 551 (e.g., keyboard), one or more pointing devices 552 (e.g., mouse, trackball, touchscreen), and/or one or more audio input devices 553. Some or all of the physical input devices 550 may include a wired or a wireless communicable coupling to the processor-based device 500.

Processor-based device users may receive output from the processor-based device 500 via one or more physical output devices 554. In at least some implementations, the one or more physical output devices 554 may include but are not limited to one or more: video output or display devices 555; tactile output devices 556; audio output devices 557, or combinations thereof. Some or all of the physical input devices 550 and some or all of the physical output devices 554 may be communicatively coupled to the processor-based device 500 via one or more wired or wireless interfaces.

For convenience, a network interface 560, the processor circuitry 502, the system memory 510, the physical input devices 550 and the physical output devices 554 are illustrated as communicatively coupled to each other via the communications link 516, thereby providing connectivity between the above-described components. In alternative embodiments, the above-described components may be communicatively coupled in a different manner than illustrated in FIG. 5. For example, one or more of the above-described components may be directly coupled to other components, or may be coupled to each other, via one or more intermediary components (not shown). In some embodiments, all or a portion of the communications link 516 may be omitted and the components are coupled directly to each other using suitable wired or wireless connections.

While FIG. 4 illustrates various operations according to one or more embodiments, it is to be understood that not all of the operations depicted in FIG. 4 are necessary for other embodiments. Indeed, it is fully contemplated herein that in other embodiments of the present disclosure, the operations depicted in FIG. 4, and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

As used in any embodiment herein, the terms “system” or “module” may refer to, for example, software, firmware and/or circuitry configured to perform any of the aforementioned operations. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry or future computing paradigms including, for example, massive parallelism, analog or quantum computing, hardware embodiments of accelerators such as neural net processors and non-silicon implementations of the above. The circuitry may, collectively or individually, be embodied as circuitry that forms part of a larger system, for example, an integrated circuit (IC), system on-chip (SoC), desktop computers, laptop computers, tablet computers, servers, smartphones, etc.

Any of the operations described herein may be implemented in a system that includes one or more mediums (e.g., non-transitory storage mediums) having stored therein, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software executed by a programmable control device.

Thus, the present disclosure is directed to systems and methods for detecting and/or preventing power analysis side-channel attacks without requiring the use of external measurement tools. A first portion of field programmable gate array (FPGA) circuitry is configured to provide emulated hardware device circuitry and a second portion of the FPGA circuitry is configured to provide power monitoring circuitry. Both the emulated hardware device circuitry and the power monitoring circuitry are coupled to FPGA power distribution network circuitry. The power monitoring circuitry includes time-to-digital converter (TDC) circuitry that includes observation delay buffers that sample a clock propagation delay. Since the voltage supplied to the buffer circuitry affects the propagation delay, the TDC circuitry outputs a binary sequence representative of one or more power delivery parameters to the emulated hardware device circuitry. Analysis circuitry uses patterns, trends, or features in the collected data representative of one or more power delivery parameters to the emulated hardware device circuitry to determine the susceptibility of the emulated hardware device circuitry to a power analysis side-channel attack.

The following examples pertain to further embodiments. The following examples of the present disclosure may comprise subject material such as at least one device, a method, at least one machine-readable medium for storing instructions that when executed cause a machine to perform acts based on the method, means for performing acts based on the method and/or a system for detecting a power analysis side channel attack using emulated hardware device circuitry and power monitoring circuitry provided using FPGA circuitry.

According to example 1, there is provided a power analysis side-channel attack vulnerability assessment system. The system may include: a configurable field-programmable gate array (FPGA) that includes: power distribution network circuitry; emulated hardware device circuitry operably coupled to the power delivery bus circuitry; memory circuitry; and power monitoring circuitry operably coupled to the power delivery bus circuitry and physically coupled to the substrate, the monitoring circuitry to: monitor one or more power delivery parameters to the emulated hardware device circuitry contemporaneous with performance of a sequence of operations by the emulated hardware device circuitry; generate output data representative of the one or more power delivery parameters; store data representative of the one or more power delivery parameters in the memory circuitry; and a host device communicatively coupleable to the configurable field-programmable gate array, the host device including analysis circuitry to: receive at least a portion of the stored data representative of the one or more power delivery parameters to the emulated hardware device circuitry; and using the received data representative of the one or more power delivery parameters to the emulated hardware device circuitry, generate an output indicative of a vulnerability of the emulated hardware device circuitry to a power analysis side-channel attack.

Example 2 may include elements of example 1 where the monitoring circuitry comprises one or more time-to-digital converter (TDC) circuits, each of the plurality of TDC circuits including a plurality delay buffer circuits configurable by the host device to provide an initial delay window containing a serially coupled, first portion, of the plurality of delay buffer circuits and a configurable observation window containing a serially coupled, second portion, of the plurality of delay buffer circuits.

Example 3 may include elements of any of examples 1 or 2 where the monitoring circuitry comprises: monitor clock circuitry; and where the configurable observation window further includes: the serially coupled second portion of the plurality of delay buffer circuits; a plurality of clocked flip-flop circuits, each of the plurality of clocked flip-flop circuits including an input coupled to an output of a respective one of the delay buffer circuits included in the serially coupled second portion of the plurality of delay buffer circuits; each of the plurality of clocked flip-flop circuits including a clocking input coupled to the monitor clock circuitry; and where the plurality of clocked flip-flops provide an output that includes a binary sequence indicative of the one or more power delivery parameters to the emulated hardware device circuitry.

Example 4 may include elements of any of examples 1 through 3 where the plurality of clocked flip-flops provide an output that includes a binary sequence indicative of a voltage supplied to the emulated hardware device circuitry based on the voltage on the power distribution network circuitry.

Example 5 may include elements of any of examples 1 through 4 where the analysis circuitry may further: generate emulated hardware device power consumption information using the emulated hardware device voltage; and correlate the emulated hardware device power consumption information with code executed by the emulated hardware device circuitry to provide the output indicative of a vulnerability of the emulated hardware device circuitry to a power analysis side-channel attack.

Example 6 may include elements of any of examples 1 through 5 where the host device further comprises configuration circuitry to configure FPGA circuitry to provide the emulated hardware device circuitry.

Example 7 may include elements of any of examples 1 through 6 where the power distribution network circuitry, the emulated hardware device circuitry, and the power monitoring circuitry are physically and operably coupled to a common FPGA substrate.

According to example 8, there is provided a power analysis side-channel attack vulnerability assessment method. The method may include: monitoring, via power monitoring circuitry coupled to emulated hardware device circuitry, one or more power delivery parameters to the emulated hardware device circuitry contemporaneous with execution of code by the hardware device emulation circuitry; generating, by the power monitoring circuitry, output data representative of the one or more power delivery parameters; causing, by the power monitoring circuitry, a storage of data representative of the one or more power delivery parameters to the emulated hardware device circuitry in memory circuitry communicatively coupled to the power monitoring circuitry; receiving by analysis circuitry communicatively coupled to the power monitoring circuitry, at least a portion of the stored data representative of the one or more power delivery parameters to the emulated hardware device circuitry; and generating, by the analysis circuitry, an output indicative of a vulnerability of the hardware device emulation circuitry to a power side-channel attack using the received data representative of the one or more power delivery parameters to the emulated hardware device circuitry.

Example 9 may include elements of example 8 where generating, by the power monitoring circuitry, output data representative of the one or more power delivery parameters to the emulated hardware device circuitry further comprises: generating, by time-to-digital converter circuitry, output data that includes a binary sequence indicative of a voltage to the hardware device emulation circuitry based on the voltage on power distribution network circuitry operably coupled to both the power monitoring circuitry and the emulated hardware device circuitry.

Example 10 may include elements of any of examples 8 or 9 where generating the output data that includes the binary sequence indicative of the voltage to the hardware device emulation circuitry further comprises: sampling, via a plurality of serially coupled observation delay buffer circuits, a clock propagation delay, wherein the voltage provided to the plurality of delay buffer circuits affects the propagation delay of each of the plurality of delay buffer; and generating the binary sequence indicative of the voltage to the emulated hardware device circuitry using an output generated by each of a plurality of D-type flip-flop (DFF) circuits, each of the plurality of DFF circuits operably coupled to an output of a respective one of the plurality of observation delay buffer circuits.

Example 11 may include elements of any of examples 8 through 10 where monitoring the one or more power delivery parameters to the hardware device emulation circuitry contemporaneous with the execution of code by the emulated hardware device circuitry further comprises: monitoring a supply voltage to the emulated hardware device circuitry contemporaneous with the execution of code by the emulated hardware device circuitry.

Example 12 may include elements of any of examples 8 through 11 and the method may additionally include: generating, by a host device communicatively coupled to the power monitoring circuitry, emulated hardware device power consumption information using the emulated hardware device voltage; and correlating, by the host device, the emulated hardware device power consumption information with code executed by the emulated hardware device circuitry to provide the output indicative of a vulnerability of the emulated hardware device circuitry to a power analysis side-channel attack.

Example 13 may include elements of any of examples 8 through 12 where monitoring, via power monitoring circuitry coupled to emulated hardware device circuitry, one or more power delivery parameters to the emulated hardware device circuitry contemporaneous with execution of code by the hardware device emulation circuitry further comprises: monitoring, via a first portion of field programmable gate array circuitry configured to provide power monitoring circuitry, one or more power delivery parameters to a second portion of the FPGA circuitry configured to provide the emulated hardware device circuitry contemporaneous with execution of code by the hardware device emulation circuitry.

According to example 14, there is provided a power analysis side-channel attack vulnerability assessment system. The system may include: means for monitoring one or more power delivery parameters to emulated hardware device circuitry contemporaneous with execution of code by the emulated hardware device circuitry; means for generating output data representative of the one or more power delivery parameters to the emulated hardware device circuitry; means for storing the data representative of the one or more power delivery parameters to the emulated hardware device circuitry in memory circuitry communicatively coupled to the power monitoring circuitry; and means for generating an output indicative of a vulnerability of the emulated hardware device circuitry to a power side-channel attack using the received data representative of the one or more power delivery parameters to the emulated hardware device circuitry.

Example 15 may include elements of example 14 where the means for generating the output data representative of the one or more power delivery parameters to the emulated hardware device circuitry further comprises: means for generating output data that includes a binary sequence indicative of a voltage to the hardware device emulation circuitry using the voltage supplied on power distribution network circuitry.

Example 16 may include elements of any of examples 14 or 15 where the means for generating the output data that includes the binary sequence indicative of the voltage to the hardware device emulation circuitry further comprises: means for sampling a clock propagation delay, wherein the voltage on the power distribution network circuitry affects the clock propagation delay; and means for generating the binary sequence using the sampled clock propagation delay.

Example 17 may include elements of any of examples 14 through 16 where the means for monitoring the one or more power delivery parameters to the emulated hardware device circuitry contemporaneous with the execution of code by the emulated hardware device circuitry further comprises: means for monitoring a supply voltage to the emulated hardware device circuitry contemporaneous with the execution of code by the emulated hardware device circuitry.

Example 18 may include elements of any of examples 14 through 17 and the system may further include: means for generating emulated hardware device power consumption information using the emulated hardware device voltage; and means for correlating the emulated hardware device power consumption information with code executed by the emulated hardware device circuitry to provide the output indicative of a vulnerability of the emulated hardware device circuitry to a power analysis side-channel attack.

According to example 19, there is provided a non-transitory storage device that includes instructions that, when executed by a host device communicatively coupled to field programmable gate array (FPGA) circuitry, cause the host device to: configure a first portion of the FPGA circuitry to provide emulated hardware device circuitry and a second portion of the FPGA circuitry to provide power monitoring circuitry; cause the power monitoring circuitry to monitor one or more power delivery parameters to the emulated hardware device circuitry contemporaneous with execution of code by the hardware device emulation circuitry; cause the power monitoring circuitry to generate output data representative of the one or more power delivery parameters to the emulated hardware device circuitry; cause the power monitoring circuitry to store the data representative of the one or more power delivery parameters to the emulated hardware device circuitry in memory circuitry communicatively coupled to the power monitoring circuitry; transfer at least a portion of the stored data representative of the one or more power delivery parameters to the hardware device emulation circuitry from the memory circuitry to analysis circuitry; and cause the analysis circuitry to generate an output indicative of a vulnerability of the emulated hardware device circuitry to a power side-channel attack using the received data representative of the one or more power delivery parameters to the emulated hardware device circuitry.

Example 20 may include elements of example 19 where the instructions that cause the power monitoring circuitry to generate output data representative of the one or more power delivery parameters to the emulated hardware device circuitry further cause the host device to: cause time-to-digital converter circuitry to generate output data that includes a binary sequence indicative of a voltage to the emulated hardware device circuitry based on a voltage on power distribution network circuitry operably coupled to both the power monitoring circuitry and the emulated hardware device circuitry.

Example 21 may include elements of any of examples 18 through 20 where the instructions that cause the time-to-digital converter circuitry to generate output data that includes a binary sequence indicative of a voltage to the emulated hardware device circuitry further cause the host device to: cause a plurality of serially coupled observation delay buffer circuits to sample a clock propagation delay, wherein the voltage provided to the plurality of delay buffer circuits affects the propagation delay of each of the plurality of delay buffer; and cause a plurality of D-type flip-flop (DFF) circuits, each of the plurality of DFF circuits operably coupled to an output of a respective one of the plurality of observation delay buffer circuits, to generate the binary sequence.

Example 22 may include elements of any of examples 18 through 21 where the instructions that cause the time-to-digital converter circuitry to monitor the one or more power delivery parameters to the hardware device emulation circuitry contemporaneous with the execution of code by the emulated hardware device circuitry further cause the host device to: cause the power monitoring circuitry to monitor a supply voltage to the emulated hardware device circuitry contemporaneous with the execution of code by the emulated hardware device circuitry.

Example 23 may include elements of any of examples 19 through 22 where the instructions further cause the host device to: generate emulated hardware device power consumption information using the emulated hardware device voltage; and correlate the emulated hardware device power consumption information with code executed by the emulated hardware device circuitry to provide the output indicative of a vulnerability of the emulated hardware device circuitry to a power analysis side-channel attack.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

What is claimed:

1. A power analysis side-channel attack vulnerability assessment system, comprising:
a configurable field-programmable gate array (FPGA) that includes:
power distribution network circuitry;
emulated hardware device circuitry operably coupled to the power delivery bus circuitry;
memory circuitry; and
power monitoring circuitry operably coupled to the power delivery bus circuitry and physically coupled to the substrate, the monitoring circuitry to:
monitor one or more power delivery parameters to the emulated hardware device circuitry contemporaneous with performance of a sequence of operations by the emulated hardware device circuitry;
generate output data representative of the one or more power delivery parameters;
store data representative of the one or more power delivery parameters in the memory circuitry; and
a host device communicatively coupleable to the configurable field-programmable gate array, the host device including analysis circuitry to:
receive at least a portion of the stored data representative of the one or more power delivery parameters to the emulated hardware device circuitry; and
using the received data representative of the one or more power delivery parameters to the emulated hardware device circuitry, generate an output indicative of a vulnerability of the emulated hardware device circuitry to a power analysis side-channel attack.

2. The system of claim 1 wherein the monitoring circuitry comprises one or more time-to-digital converter (TDC) circuits, each of the plurality of TDC circuits including a plurality delay buffer circuits configurable by the host device to provide an initial delay window containing a serially coupled, first portion, of the plurality of delay buffer circuits and a configurable observation window containing a serially coupled, second portion, of the plurality of delay buffer circuits.

3. The system of claim 2:
wherein the monitoring circuitry comprises:
monitor clock circuitry; and
wherein the configurable observation window further includes:
the serially coupled second portion of the plurality of delay buffer circuits;
a plurality of clocked flip-flop circuits,
each of the plurality of clocked flip-flop circuits including an input coupled to an output of a respective one of the delay buffer circuits included in the serially coupled second portion of the plurality of delay buffer circuits;
each of the plurality of clocked flip-flop circuits including a clocking input coupled to the monitor clock circuitry; and
wherein the plurality of clocked flip-flops provide an output that includes a binary sequence indicative of the one or more power delivery parameters to the emulated hardware device circuitry.

4. The system of claim 3 wherein the plurality of clocked flip-flops provide an output that includes a binary sequence indicative of a voltage supplied to the emulated hardware device circuitry based on the voltage on the power distribution network circuitry.

5. The system of claim 4 wherein the analysis circuitry further to:
generate emulated hardware device power consumption information using the emulated hardware device voltage; and
correlate the emulated hardware device power consumption information with code executed by the emulated hardware device circuitry to provide the output indicative of a vulnerability of the emulated hardware device circuitry to a power analysis side-channel attack.

6. The system of claim 1 wherein the host device further comprises configuration circuitry to configure FPGA circuitry to provide the emulated hardware device circuitry.

7. The system of claim 1 wherein the power distribution network circuitry, the emulated hardware device circuitry, and the power monitoring circuitry are physically and operably coupled to a common FPGA substrate.

8. A power analysis side-channel attack vulnerability assessment method, comprising:
apportioning FPGA circuitry into a first portion to provide emulated hardware device circuitry and a second portion to provide power monitoring circuitry;
monitoring, via the power monitoring circuitry coupled to the emulated hardware device circuitry, one or more power delivery parameters to the emulated hardware device circuitry contemporaneous with execution of code by the hardware device emulation circuitry;
generating, by the power monitoring circuitry, output data representative of the one or more power delivery parameters;
causing, by the power monitoring circuitry, a storage of data representative of the one or more power delivery parameters to the emulated hardware device circuitry in memory circuitry communicatively coupled to the power monitoring circuitry;
receiving by analysis circuitry communicatively coupled to the power monitoring circuitry, at least a portion of the stored data representative of the one or more power delivery parameters to the emulated hardware device circuitry; and
generating, by the analysis circuitry, an output indicative of a vulnerability of the hardware device emulation circuitry to a power side-channel attack using the received data representative of the one or more power delivery parameters to the emulated hardware device circuitry.

9. The method of claim 8 wherein generating, by the power monitoring circuitry, output data representative of the one or more power delivery parameters to the emulated hardware device circuitry further comprises:
generating, by time-to-digital converter circuitry, output data that includes a binary sequence indicative of a voltage to the hardware device emulation circuitry based on the voltage on power distribution network circuitry operably coupled to both the power monitoring circuitry and the emulated hardware device circuitry.

10. The method of claim 9 wherein generating the output data that includes the binary sequence indicative of the voltage to the hardware device emulation circuitry further comprises:
sampling, via a plurality of serially coupled observation delay buffer circuits, a clock propagation delay, wherein the voltage provided to the plurality of delay buffer circuits affects the propagation delay of each of the plurality of delay buffer; and
generating the binary sequence indicative of the voltage to the emulated hardware device circuitry using an output generated by each of a plurality of D-type flip-flop (DFF) circuits, each of the plurality of DFF circuits operably coupled to an output of a respective one of the plurality of observation delay buffer circuits.

11. The method of claim 8 wherein monitoring the one or more power delivery parameters to the hardware device emulation circuitry contemporaneous with the execution of code by the emulated hardware device circuitry further comprises:
monitoring a supply voltage to the emulated hardware device circuitry contemporaneous with the execution of code by the emulated hardware device circuitry.

12. The method of claim 11, further comprising:
generating, by a host device communicatively coupled to the power monitoring circuitry, emulated hardware device power consumption information using the emulated hardware device voltage; and
correlating, by the host device, the emulated hardware device power consumption information with code executed by the emulated hardware device circuitry to provide the output indicative of a vulnerability of the emulated hardware device circuitry to a power analysis side-channel attack.

13. The method of claim 8 wherein monitoring, via power monitoring circuitry coupled to emulated hardware device circuitry, one or more power delivery parameters to the emulated hardware device circuitry contemporaneous with execution of code by the hardware device emulation circuitry further comprises:
monitoring, via a first portion of field programmable gate array circuitry configured to provide power monitoring circuitry, one or more power delivery parameters to a second portion of the FPGA circuitry configured to provide the emulated hardware device circuitry contemporaneous with execution of code by the hardware device emulation circuitry.

14. A power analysis side-channel attack vulnerability assessment system, comprising:
means for apportioning FPGA circuitry into a first portion to provide emulated hardware device circuitry and a second portion to provide power monitoring circuitry;
means for monitoring one or more power delivery parameters to emulated hardware device circuitry contemporaneous with execution of code by the emulated hardware device circuitry;
means for generating output data representative of the one or more power delivery parameters to the emulated hardware device circuitry;
means for storing the data representative of the one or more power delivery parameters to the emulated hardware device circuitry in memory circuitry communicatively coupled to the power monitoring circuitry; and
means for generating an output indicative of a vulnerability of the emulated hardware device circuitry to a power side-channel attack using the received data representative of the one or more power delivery parameters to the emulated hardware device circuitry.

15. The system of claim 14 wherein the means for generating the output data representative of the one or more power delivery parameters to the emulated hardware device circuitry further comprises:
means for generating output data that includes a binary sequence indicative of a voltage to the hardware device emulation circuitry using the voltage supplied on power distribution network circuitry.

16. The system of claim 15 wherein the means for generating the output data that includes the binary sequence indicative of the voltage to the hardware device emulation circuitry further comprises:
means for sampling a clock propagation delay, wherein the voltage on the power distribution network circuitry affects the clock propagation delay; and
means for generating the binary sequence using the sampled clock propagation delay.

17. The system of claim 14 wherein the means for monitoring the one or more power delivery parameters to the emulated hardware device circuitry contemporaneous with the execution of code by the emulated hardware device circuitry further comprises:
means for monitoring a supply voltage to the emulated hardware device circuitry contemporaneous with the execution of code by the emulated hardware device circuitry.

18. The system of claim 17, further comprising:
means for generating emulated hardware device power consumption information using the emulated hardware device voltage; and
means for correlating the emulated hardware device power consumption information with code executed by the emulated hardware device circuitry to provide the output indicative of a vulnerability of the emulated hardware device circuitry to a power analysis side-channel attack.

19. A non-transitory storage device that includes instructions that, when executed by a host device communicatively coupled to field programmable gate array (FPGA) circuitry, cause the host device to:
configure a first portion of the FPGA circuitry to provide emulated hardware device circuitry and a second portion of the FPGA circuitry to provide power monitoring circuitry;
cause the power monitoring circuitry to monitor one or more power delivery parameters to the emulated hardware device circuitry contemporaneous with execution of code by the hardware device emulation circuitry;
cause the power monitoring circuitry to generate output data representative of the one or more power delivery parameters to the emulated hardware device circuitry;
cause the power monitoring circuitry to store the data representative of the one or more power delivery parameters to the emulated hardware device circuitry in memory circuitry communicatively coupled to the power monitoring circuitry; and
transfer at least a portion of the stored data representative of the one or more power delivery parameters to the hardware device emulation circuitry from the memory circuitry to analysis circuitry; and
cause the analysis circuitry to generate an output indicative of a vulnerability of the emulated hardware device circuitry to a power side-channel attack using the received data representative of the one or more power delivery parameters to the emulated hardware device circuitry.

20. The non-transitory storage device of claim 19 wherein the instructions that cause the power monitoring circuitry to generate output data representative of the one or more power delivery parameters to the emulated hardware device circuitry further cause the host device to:
cause time-to-digital converter circuitry to generate output data that includes a binary sequence indicative of a voltage to the emulated hardware device circuitry based on a voltage on power distribution network circuitry operably coupled to both the power monitoring circuitry and the emulated hardware device circuitry.

21. The non-transitory storage device of claim 20 wherein the instructions that cause the time-to-digital converter circuitry to generate output data that includes a binary sequence indicative of a voltage to the emulated hardware device circuitry further cause the host device to:
cause a plurality of serially coupled observation delay buffer circuits to sample a clock propagation delay, wherein the voltage provided to the plurality of delay buffer circuits affects the propagation delay of each of the plurality of delay buffer; and
cause a plurality of D-type flip-flop (DFF) circuits, each of the plurality of DFF circuits operably coupled to an output of a respective one of the plurality of observation delay buffer circuits, to generate the binary sequence.

22. The non-transitory storage device of claim 19 wherein the instructions that cause the time-to-digital converter circuitry to monitor the one or more power delivery parameters to the hardware device emulation circuitry contemporaneous with the execution of code by the emulated hardware device circuitry further cause the host device to:
cause the power monitoring circuitry to monitor a supply voltage to the emulated hardware device circuitry contemporaneous with the execution of code by the emulated hardware device circuitry.

23. The non-transitory storage device of claim 22 wherein the instructions further cause the host device to:
generate emulated hardware device power consumption information using the emulated hardware device voltage; and
correlate the emulated hardware device power consumption information with code executed by the emulated hardware device circuitry to provide the output indicative of a vulnerability of the emulated hardware device circuitry to a power analysis side-channel attack.
